(19) United States
(12) Patent Application Publication
(10) Pub. No.: US 2014/0068448 A1
(43) Pub. Date: Mar. 6, 2014

(54) PRODUCTION DATA MANAGEMENT SYSTEM UTILITY

(71) Applicant: Brandon David Plost, Houston, TX (US)

(72) Inventor: Brandon David Plost, Houston, TX (US)

(21) Appl. No.: 13/596,601

(22) Filed: Aug. 28, 2012

(51) Int. Cl. G06F 3/0481

(52) U.S. Cl. CPC G06F 3/0481
USPC 715/738

(57) ABSTRACT

A method can include providing an object that represents at least selected menu items that contextualize a graphical user interface rendered by an instance of a production data management system framework in conjunction with data from at least one data source; receiving a request to store the contextualized graphical user interface; responsive to the request, serializing the object to mark-up language; and storing the mark-up language as a file to a data storage device, the file configured for subsequent deserializing of the mark-up language for generating a copy of the object and for rendering of the contextualized graphical user interface according to the copy of the object. Various other apparatuses, systems, methods, etc., are also disclosed.

### BACKGROUND

In oil and gas industries, production operations management systems find use in management of assets, for example, to achieve production targets. As an example, a production operations management system may collect various types of data from disparate sources in an effort to present a more complete and up-to-date view of production operations. Given such a view, decisions may be made to manage operations related to production. Various technologies, techniques, etc., described herein relate generally to utilities for production data management systems or other systems.

### SUMMARY

A method can include providing an object that represents at least selected menu items that contextualize a graphical user interface rendered by an instance of a framework in conjunction with data from at least one data source; receiving a request to store the contextualized graphical user interface; responsive to the request, serializing the object to mark-up language; and storing the markup language as a file to a data storage device. As an example, a system can include instructions stored in memory and executable by one or more processors to execute an instance of framework; render a graphical user interface of the framework that includes user selectable items to contextualize the graphical user interface and data from at least one data storage device; receive commands for selection of one or more of the user selectable items to contextualize the graphical user interface; generate an object that represents the contextualized graphical user interface and data from the at least one data storage device; responsive to receipt of a request, seriealize the object to mark-up language; and store the mark-up language as a file.

As an example, instructions to instruct a computing device can include instructions to receive a file that includes serialized language and information for accessing one or more data storages; deserialize the language and information for accessing the one or more data storages; execute an instance of a framework; and generate a graphical user interface of the framework based at least in part on the deserialized language and information for accessing the one or more data storages. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various components for simulating a geological environment;

FIG. 2 illustrates an example of a production data management system framework;

FIG. 3 illustrates an example of a system and an example of a method;

FIG. 4 shows an example of a graphical user interface;

FIG. 5 illustrates an example of a method for serializing and deserializing information;

FIG. 6 illustrates an example of a method for serializing an object;

FIG. 7 illustrates an example of a system and an example of a method for setting one or more options as to properties of an object, a file, etc.;

FIG. 8 illustrates an example of a method for creating a snapshot file;

FIG. 9 illustrates an example of a method for setting selected setting within an application based on information in a snapshot file; and

FIG. 10 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

Various examples of technologies and techniques are described herein, for example, for providing functionality to a production data management system framework. As an example, a utility may provide for storing a context established by a user within a production data management system framework and subsequently re-establishing the context. As an example, the context may be stored in the form of mark-up language in a file, for example, by serializing an object that represents the context to mark-up language. In such an example, deserialization of the mark-up language may allow for generation of a copy of the object, for example, by an instance of the production data management system framework (e.g., a utility of the framework) to reestablish the context. As an example, serialization of an object that represents a contextualized graphical user interface may result in information in the form of a file, for example, where the serialization acts to obscure content (e.g., to dissuade user manipulation, alteration, etc.).

As an example, mark-up language may be serialized in a binary form (e.g., binary XML). As an example, a compressor such as a configurable XML compressor may be implemented to separates structure, layout and data and, for example, to distribute data elements into separate data streams (int, char, string, base64, etc.). Various schemes may obscure mark-up language and optionally other information to confound queries, etc., as to content. As an example, the .NET Binary Format: XML Data Structure (Microsoft Corporation, Redmond, Wash.) may be implemented, which is a binary format that can represent an XML document (e.g., as specified in by the XML1.0 standard). Such a binary format may act to reduce processing costs associated with XML documents by encoding an XML document in fewer bytes than the same document encoded in UTF-8 (e.g., as specified in the RFC2279 standard) and may confound ease of human readability of content.

In various examples, a context such as a contextualized graphical user interface may include data from one or more data sources, which may be disparate data sources (e.g., as associated with different frameworks, equipment, functionalities, etc.). As an example, a method can include providing an object that includes information for accessing data of a contextualized graphical user interface (e.g., to re-establish a user defined context) and serialization of the object, for example, to a mark-up language (e.g., in the form of a file).

As an example, a method can include providing an object that represents at least selected menu items that contextualize a graphical user interface rendered by an instance of a production data management system framework in conjunction with data from at least one data source; receiving a request to store the contextualized graphical user interface; responsive to the request, serializing the object to mark-up language; and storing the mark-up language as a file to a data storage device, the file configured for subsequent deserializing of the markup language for generating a copy of the object and for rendering of the contextualized graphical user interface according to the copy of the object. In such an example, serializing the object may provide mark-up language in the form of a file, for example, for storage according to a file system.

In data storage and transmission, serialization can include converting a data structure or object state into a format that can be stored (e.g., in a file, in a memory buffer, in a manner for transmission via a network interface) or, optionally, streamed. A process to resurrect the data structure or object state may be referred to a deserialization, for example, by parsing a series of bits according to the serialization format to create a semantically identical clone of the original. For complex objects of an object-oriented programming framework, such as those that make extensive use of references, serialization and deserialization can be more complex and, for example, may not include associated methods with which such an object may be inextricably linked. Other terms used to describe serialization can include “deflating” and “marshaling”; whereas, for deserialization (e.g., extracting a data structure from a series of bytes), terms such as “inflating” and “unmarshaling” may be used. As an example, language for a context may be packed into a file or an object and subsequently unpacked to reconstruct the context. Packing may include serialization or other process while unpacking may include deserialization or other process. Packing may form a pack or package, while unpacking may unpack a pack or package.

As an example, the .NET framework (Microsoft Corporation, Redmond, Wash.) can include a method (e.g., a class) for XML serialization as a process for converting an object's public properties and fields to a serial format (in this case, XML) for storage or transport. Also provided is functionality for deserialization to re-creates the object (e.g., a copy) in its original state from XML of an XML serialization process. XML serialization can provide a mechanism to save the state of an object, for example, into a stream, a buffer, etc.

As mentioned, in oil and gas industries, a production operations management system framework may collect various types of data from disparate sources in an effort to present a more complete and up-to-date view of production operations. Given such a view, decisions may be made to manage operations related to production. As such decisions may involve more than one person, a user may want to share a context to enhance decision making. As an example, responsive to a request to share a context of an instance of a production data management system framework, a file may be created and transmitted to a computer executing another instance of the production data management system framework. Upon receipt of the file, the production data management system framework may process the file to establish the context and effectuate sharing (e.g., for collaborative decision making, etc.). Sharing may occur, for example, via a communication application such as an instant messenger application (IM), an email application, a cellular application, etc.

As another example, consider that decision making may involve several days, weeks, etc., of analysis. Thus, at the end of a day's session, a user may request storage of a context, for example, to resume at a later time. In such an example, the context may be stored locally, remotely, or locally and remotely. Further, the context may be operating system agnostic in that an instance of a production data management system framework executing on one platform with a first operating system may store a context in a form for consumption by another instance of the production data management system framework executing on another platform with a second, different operating system. As to some examples of operating systems, consider WINDOW® operating systems (e.g., WINDOWS 7, WINDOWS 8, etc., of Microsoft Corporation, Redmond, Wash.), APPLE® operating systems (e.g., iOS, etc. of Apple, Inc., Cupertino, Calif.), UNIX® operating systems (The Open Group, San Francisco, Calif.), etc.

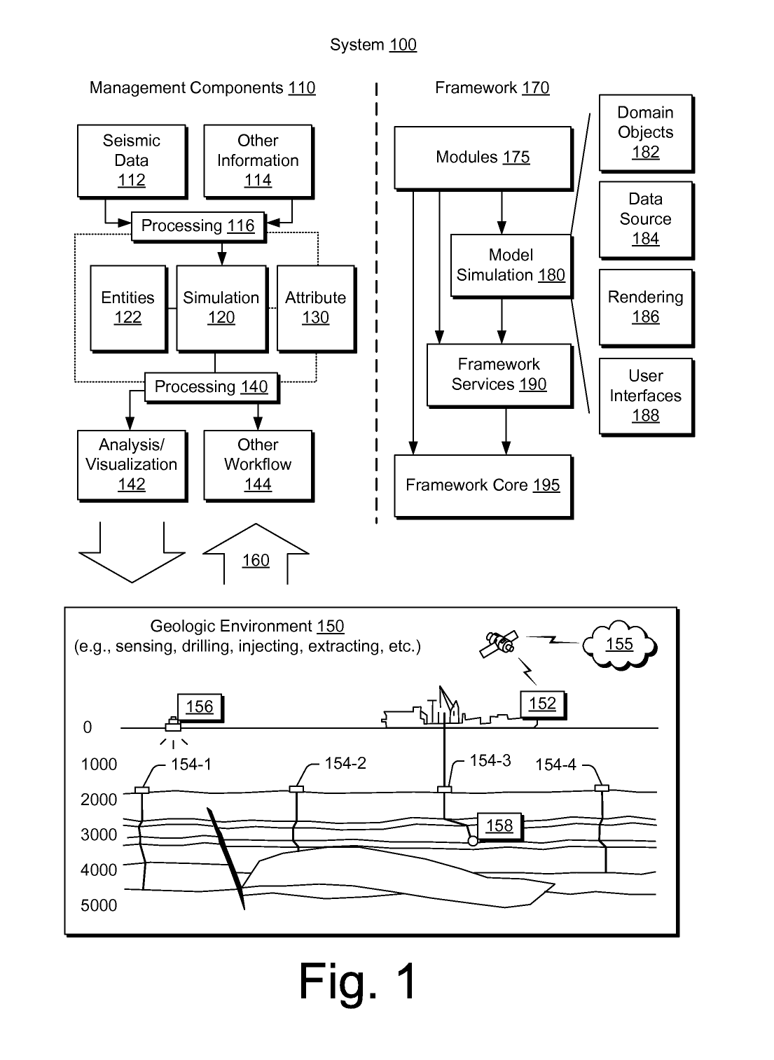

Various examples of techniques, technologies, etc., are described below, where FIG. 1 shows a system 100 with respect to a geologic environment that includes various wells, which may be analyzed using a production data management system framework. While FIG. 1 shows a subsea environment, techniques, technologies, etc., described herein may be applied to other environments. Further, while various examples pertain to wells associated with hydrocarbons, techniques, technologies, etc., described herein may be applied to other types of wells (e.g., water, carbon dioxide, etc.).

FIG. 1 shows an example of a system 100 that includes various management components 110 to manage various aspects of a geologic environment 150 (e.g., an environment that includes a sedimentary basin). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114).

In an example embodiment, the simulation component 120 may rely on a software framework such as an object-based framework. In such a framework, entities may include entities based on pre-defined classes to facilitate modeling and simulation. A commercially available example of an object-based framework is the MICROSOFT®.NET™ framework (Redmond, Wash.), which provides a set of extensible object classes. In the .NET™ framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120. Alternatively, or in addition, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results. Additionally, or alternatively, output from the simulation component 120 may be input to one or more other workflows, as indicated by a workflow component 144.

In an example embodiment, the management components 110 may include features of a commercially available simulation framework such as the PETREL® seismic to simulation software framework (Schlumberger Limited, Houston, Tex.). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of simulating a geologic environment).

In an example embodiment, various aspects of the management components 110 may include add-ons or plug-ins that operate according to specifications of a framework environment. For example, a commercially available framework environment marketed as the OCEAN® framework environment (Schlumberger Limited, Houston, Tex.) allows for seamless integration of add-ons (or plug-ins) into a PETREL® framework workflow. The OCEAN® framework environment leverages .NET® tools (Microsoft Corporation, Redmond, Wash.) and offers stable, user-friendly interfaces for efficient development. In an example embodiment, various components (e.g., or modules) may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization. Such a model may include one or more grids (e.g., defined by nodes).

The model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components (e.g., for GUI generation, rendering and interaction).

In the example of FIG. 1, the domain objects 182 can include entity objects, property objects and optionally other objects. Entity objects may be used to geometrically represent wells, surfaces, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project and, at a later time, the project may be accessed (e.g., by the same user, another user, an executing program, etc.) and restored using the model simulation layer 180, which can re-create instances of the relevant domain objects.

In the example of FIG. 1, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 158, which may be equipment to drill, acquire information, assist with resource recovery, etc. Other equipment 156 may be located remote from a well site and include processing, sensing, detecting, emitting or other circuitry. Such equipment may include storage and communication circuitry to store and to communicate data, instructions, etc. The geologic environment 150 also shows various wells (e.g., wellbores) 154-1, 154-2, 154-3 and 154-4. In the example of FIG. 1, the downhole equipment 155 may include a drill for drilling the well 154-3. In such an example, the wells 154-1, 154-2 and 154-3 may be referred to as offset wells.

The framework 170 may provide for modeling the geologic environment 150 including the wells 154-1, 154-2, 154-3 and 154-4 as well as stratigraphic layers, lithologies, faults, etc. The framework 170 may create a model with one or more grids, for example, defined by nodes, where a numerical technique can be applied to relevant equations discretized according to at least one of the one or more grids. As an example, the framework 170 may provide for performing a simulation of phenomena associated with the geologic environment 150 using at least a portion of a grid. As to performing a simulation, such a simulation may include interpolating geological rock types, interpolating petrophysical properties, simulating fluid flow, or other calculating (e.g., or a combination of any of the foregoing).

Production and petroleum engineers, along with economists and analysts may use a production data management system framework to view historical data from an oilfield, run calculations, and create reports (e.g., among other tasks). In a production data and management framework, a bookmark may represent a particular save point or context in which a user is viewing data, for example, which the user may wish to return to at a later time, or which the user may want to share with colleagues.

As an example, when a user makes a request to create a bookmark, a utility of a production data and management framework may determine the metes and bounds of a current context (e.g., data and settings) as a “save point”. In such an example, settings may include parameters associated with user options, the data being viewed, and the date context. As an example, various settings may be selectable via menus or other controls of a graphical user interface (e.g., menus, drop-downs, checkboxes, etc.). As an example, a utility may respond to receipt of a request or an event (e.g., a timed event, etc.) to create a bookmark representing a “save point” where the bookmark includes pointers to current data and settings. Such a bookmark may be a collection of relevant information which may be saved, for example, to a file on a user's computer (e.g., which can be later sent to colleagues if desired). In such an example, the file may or may not be compressed or encrypted before being saved to the user's computer (e.g., or other location).

As an example, given a stored bookmark, a user may later initiate a process to restore the bookmark to re-create a context using the data and settings associated with the bookmark. Such a process may retrieve the bookmark (e.g., object, file, etc.) from a storage location. In such an example, the bookmark may store information sufficient to re-create the context, which may include pointers, links, etc., to information to be retrieved from one or more databases. Where a production data and management framework includes or is interoperable with a bookmark utility (e.g., to create and restore bookmarks, etc.), the utility may instruct the production data and management framework to re-create an entire screen context along with its associated data (e.g., rendered to a display, a projector, etc.).

As an example, a production data and management client (e.g., as in a client/server or front end/back end type of architecture) may accept user inputs as to what to display (e.g., a screen context). As an example, a screen context may be in the form of an overarching graphical user interface or a collection of graphical user interfaces. As an example, a production data and management client may retrieve selected data from a production data and management database, which in turn, may optionally access one or more additional databases.

As an example, one or more graphical user interfaces, initiation files, etc., may allow a user to set (e.g., specify) one or more settings. As an example, a setting may be specified by user inputs to a production data and management client (e.g., an instance of a front end or client associated with one or more servers). As to some examples, settings may include type(s) of data displayed, features displayed, data source, display preferences, etc. Types of data displayed may include, for example, raw data, processed data, verified data, etc. Data displayed may also include, for example, date-sensitive data, where a date may be selected as a user setting (e.g., via a calendar menu, a calendar field, etc.). As an example, a user may select a preference for viewing one type of data over another, where that preference may filter out certain date ranges, or may filter out raw or processed data.

As an example, one or more features displayed may be certain graphical preferences set within a production data management system framework. For example, such preferences may include preferences as to what to display in a graph of historical data, what filters are set within a property grid, etc. As an example, one or more graphic preferences may include one or more graphic traits of a visualization, for example, such as a color or a color scheme, a line thickness, a zoom factor, a text font, etc. As an example, a display preference may also include one or more preferences as to screen layout (e.g., size, aspect ratio, tiling, landscape, portrait, etc.).

As an example, a method for creating a bookmark for production data management system framework can include displaying a set of production data on a computer screen; receiving a request to create the bookmark, where the bookmark represents a state of the displayed data and data context, and may include one or more of the settings of the production data and management framework; determining the settings; and creating the bookmark.

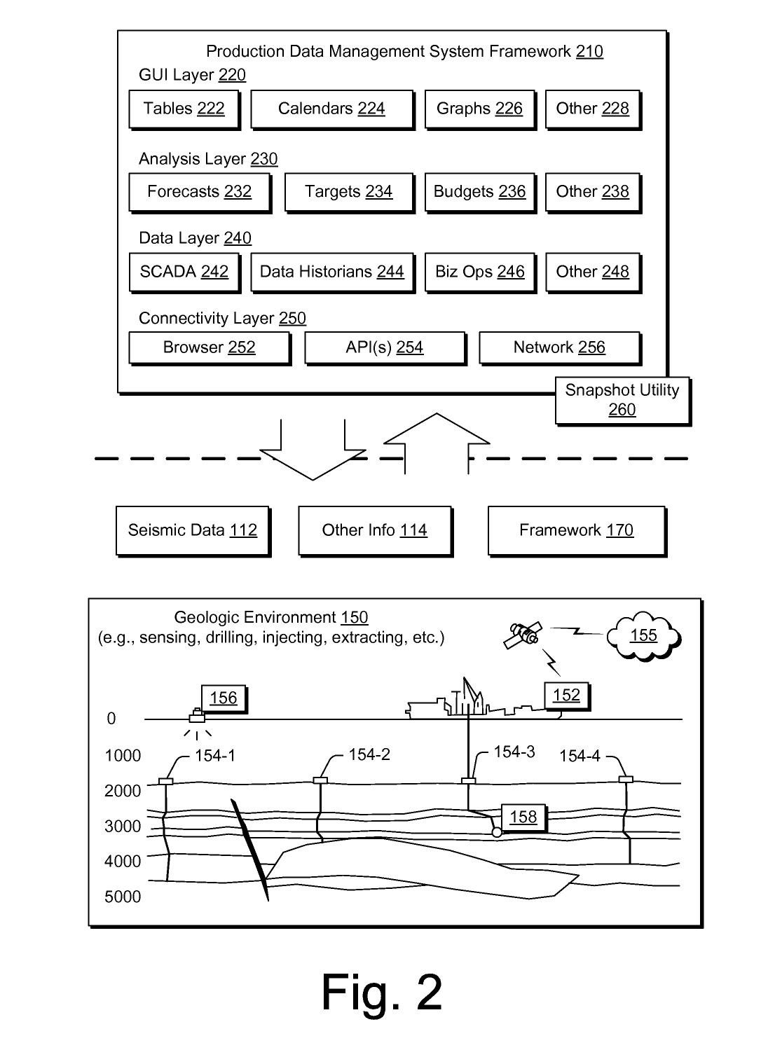

FIG. 2 shows an example of a production data management system framework 210, which includes a graphical user interface (GUI) layer 220, an analysis layer 230, a data layer 240 and a connectivity layer 250 as well as a snapshot utility 260 (e.g., or bookmark utility). As an example, the production data management system framework 210 may receive information such information associated with one or more components of the example of FIG. 1. For example, FIG. 2 shows the production data management system framework 210 as receiving the seismic data 112 and the other information 114 as well as being interoperable with the framework 170 and one or more items of the geologic environment 150.

In the example of FIG. 2, the GUI layer 220 includes a tables module 222, a calendars module 224, a graphs module 226 and one or more other modules 228; the analysis layer 230 includes a forecasts module 232, a targets module 234, a budgets module 236 and one or more other modules 238; the data layer 240 includes a SCADA module 240, a data historians module 244, a business operations module 246 and one or more other modules 248; and the connectivity layer 250 includes a browser module 252, an application programming interface (API) module 254 and a network module 256. In the example of FIG. 2, the utility 260 may be part of the framework 210 or may be an add-in, a plug-in, etc.

As an example the framework 210 may include various features of the AVOCET® production operations software framework (Schlumberger, Houston, Tex.), which may be considered a production data management system framework. The AVOCET® framework includes features for workflow automation, online artificial lift management, predictive data analysis for candidate selection, web-based key performance indicators visualization for review of operations, etc.

The AVOCET® framework can connect to engineering simulation models and analytical applications, for example, to provide insight into root causes of production shortfalls, to improve production operations management, etc. The AVOCET® framework may provide features that allow for consideration of a broad range of asset disciplines. The AVOCET® framework may integrate well operations and production management systems, for example, including capture and validation of field data, production, and equipment surveillance and tracking specialized oilfield operations. The AVOCET® framework includes functionality for unification of various data, which may be data from disparate data sources, as well as bridging such data with one or more engineering models in user environment that allows users to identify problems more quickly, minimizing downtime and enabling continuous production optimization.

As an example, a production data management systems framework may benefit field staff, production and reservoir engineers, production accountants, administrators, etc. One or more graphical user interfaces may be contextualized to view asset performance, monitor KPIs, visualize relevant information that can affect production, impact performance, etc. As an example, performance metrics may be visualized, including allocated production against plan for a full portfolio of assets. As an example, a programming framework (e.g., the MICROSOFT® SILVERLIGHT® framework) may support access to a production data management system framework, for example, via a network (e.g., the Internet) for data entry, validation, contextualization, viewing of information (e.g., in the field, office, mobile device, etc., where underlying platforms, operating systems, etc., may differ).

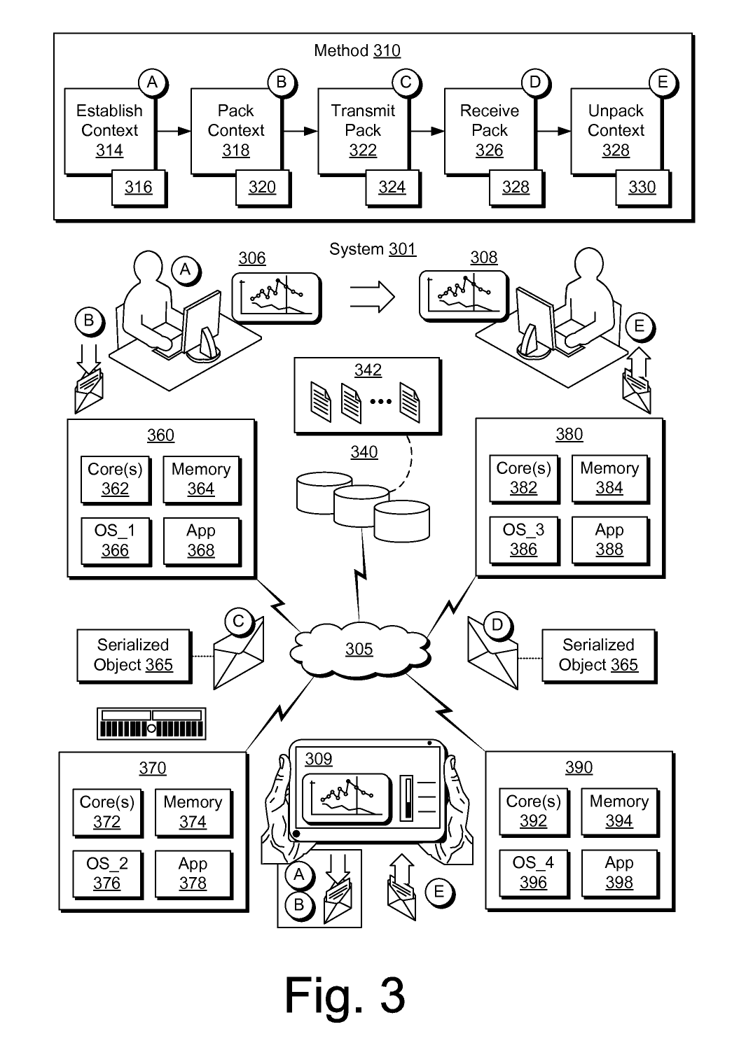

FIG. 3 shows an example of a system 301 and an example of a method 310, which may be performed using the system 301. The system 301 includes computing devices 360, 370, 380 and 390, each of which includes one or more cores 362, 372, 382, 392 and memory 364, 374, 384, 394. In the example of FIG. 3, the computing devices 360, 370, 380 and 390 may include the same or different operating systems 366, 376, 386 and 396, for example, depending on underlying hardware or one or more other factors. For example, the operating system 396 of the computing device 390 may be an operating system configured for mobile computing (e.g., the computing device 390 may be a mobile device, optionally include circuitry for cellular, satellite or other communication). Such an operating system may have a restricted file system, for example, compared to an operating system that may be found in a desktop, a server, a notebook, etc.

In the example of FIG. 3, the computing devices 360, 370, 380 and 390 includes network interfaces (not shown) for connecting to one or more networks 305, which may provide for access to one or more data storage devices 340 (e.g., databases). As to a client/server architecture, each of the computing devices 360, 370, 380 and 390 includes an application 368, 378, 388 and 398. These applications may differ based on architecture, for example, where the computing device 370 is a server and the computing device 390 is a client device and the application 378 is a server-side application and the application 398 is a client-side application.

As an example, a client-side application may be associated with a browser application (e.g., including a run-time engine, a virtual machine, etc.). As to an application framework for client/server interactions, as an example, a framework such as the MICROSOFT® SILVERLIGHT® framework may be implemented. The SILVERLIGHT® framework provides for writing and running network (e.g., Internet or other network) applications, for example, using a plug-in for a web browser (e.g., WINDOWS® OS or APPLE® MAC® OS). In the SILVERLIGHT® framework, user interfaces can be declared in Extensible Application Mark-up Language (XAML) and programmed using a subset of the .NET framework. As an example, XAML can be used for marking up vector graphics and animations. While a client/server architecture is mentioned, as an example, one or more other types of “split” architectures may be implemented.

In the example of FIG. 3, the computing devices 360, 380 and 390 are shown as having associated graphical user interfaces 306, 308 and 309 where the graphical user interfaces 308 and 309 stem from a context of the graphical user interface 306 (e.g., a contextualized graphical user interface).

As to the method 310, it includes an establish block 314 for establishing a context (e.g., “A”), a pack block 318 for packing the context as a pack (e.g., “B”), a transmission block 322 for transmitting the pack (e.g., “C”), a reception block 326 for receiving the transmitted pack (e.g., “D”), and an unpack block 328 for unpacking the context from the pack (e.g., “E”).

The system 301 includes labels A, B, C, D and E, which correspond to various actions of the method 310. For example, a user at the computing device 360 may establish a context (A), request packing of the context as a pack (B), and initiate transmission of the pack (C). In such an example, the network 305 may direct the transmitted pack to the data storage 340, for example, for storage with one or more other packs 342, and may direct the transmitted pack to one or more of the computing devices 370, 380 and 390. In the example of FIG. 3, the computing device 380 receives the pack (D) and unpacks the context from the pack (E). As to the computing device 390, the pack may be directed to the computing device 370 as a server-side device interoperable with the computing device 390 as a client-side device or the pack may be directed to the computing device 390 where the application 398 includes instructions for unpacking the context (E) from the pack and for establishing the context (see, e.g., the GUI 309). As indicated, the computing device 390 may provide for establishing a context (A) and request packing of the context as a pack (B), for example, for storage, transmission, etc.

In the example of FIG. 3, the pack transmitted by the computing device 360 (C) is shown as optionally being serialized object 365 such that the computing device 380 receives the pack as a serialized object 365 (D). As mentioned, packing of a context may include serialization (e.g., mark-up language serialization, object serialization, binary serialization, etc.). In the example of FIG. 3, the data storage 340 may optionally store one or more packs, optionally of different formats, permissions, users, groups, projects, etc. As an example, a pack may be a file, an object, a blob, etc. As an example, a pack may be unencrypted or encrypted (e.g., using one or more keys), compressed or uncompressed, etc.

In the example of FIG. 3, the applications 368, 388, 378 and 398 may be provided subject to one or more licenses. Code for such applications may be secure and operable to those that possess such one or more licenses. Further, the data storage 340 may be secure and accessible by those possessing such one or more licenses or otherwise possessing one or more credentials that allow for at least some access to data stored therein.

As an example, the computing devices 360, 380 and 390 may include communication functionality provided by one or more applications, for example, an instant messaging application, an email application, a text messaging application, a cellular application (e.g., 3 G, 4 G, etc.), etc. Upon receipt of a request to pack a context as a pack, one or more communication applications may be called for transmitting the pack (e.g., to facilitate collaboration). For example, a user at the computing device 360 may request packing of a context as a pack where an email application opens an email message with the pack as an attachment. Upon the user entering an email address, the pack may be sent to that address as an attachment. The pack may include a specific file extension or be an executable to be recognized upon receipt as being associated with the appropriate application, for example, a production data management system framework. As an example, upon receipt, a user at the computing device 380 may double click or other activate the pack to commence unpacking of the context and establishing the context locally (see, e.g., the GUI 308).

The method 310 is shown in FIG. 3 in association with various computer-readable media (CRM) blocks 316, 320, 324, 328 and 330. Such blocks generally include instructions suitable for execution by one or more processors (or cores) to instruct a computing device or system to perform one or more actions. While various blocks are shown, a single medium may be configured with instructions to allow for, at least in part, performance of various actions of the method 310. As an example, a computer-readable medium (CRM) may be a computer-readable storage medium. One or more CRM block may be provided for GUIs, etc. (see, e.g., GUIs 306, 308 and 309).

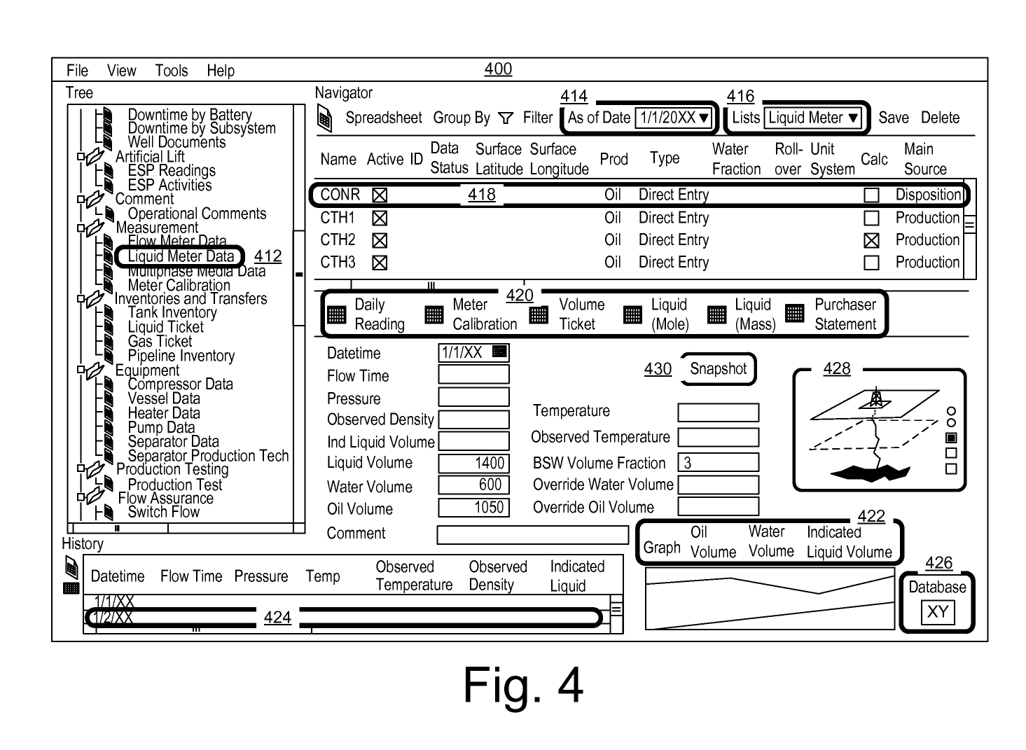

FIG. 4 shows an example of a graphical user interface 400 having a context, for example, as established at least in part by user selected options. For example, a user may select a screen type from a tree 412 (e.g., “Liquid Meter Data”), select a navigator date from a calendar control 414, select an item from a filter list 416 (e.g., “Liquid Meter”), select a name of a data entry 418 (e.g., “CONR”) as a selected item, select a screen link toolbar 420, select a graph definition 422, select a history grid row 424, select a database 426 and select a graphic 428 (e.g., model, image, geodata, etc.). FIG. 4 also shows a “snapshot” graphic control 430 (e.g., a button, etc.), which when selected may present an interface for “taking” a snapshot, loading a snapshot, etc. As an example, such a control may include one or more associated settings (e.g., setting a format, selecting one or more portions of a graphical user interface, selecting a communication means, selecting a storage means, setting a timer for timing action, etc.).

In the example of FIG. 4, the various graphics and graphical controls may be part of a front-end or client-side functionality associated with a production data management system framework. For example, as mentioned, in SILVERLIGHT® framework, user interfaces can be declared in Extensible Application Mark-up Language (XAML) and programmed using a subset of the .NET framework. Thus, each of the selections that define a context may have associated mark-up language (e.g., to represent user selections). As an example, a context may be an object defined within a framework such as an object-oriented framework. As an example, such an object may be amenable to serialization, for example, to convert its properties and fields to a serial format (e.g., in a mark-up language).

As an example of contextualization, consider the graph selection or selections 422 as including items such as min, max, line type, colors, metadata, dates, other personal customizations, etc. Such selections may be represented in the form of an object (e.g., object properties, fields, etc.). Also, such selections may be made by a user to assist in decision making, for example, to highlight certain data exhibiting behavior to be saved, shared, saved and shared, etc. For example, a user may desire sharing of a graph with a consultant or other individual that has expertise in analyzing such behavior and initiate a packing (e.g., serialization) process to pack the graph as a context, for example, in the form of a file. Further, upon re-establishing the context on another computing device, the consultant or other individual may perform additional customizations and optionally store those as a context, for example, for possible transmission back to the individual that made the original request for assistance. As an example, the consultant or other individual may include one or more comments in a comment field (e.g., “I narrowed the range for x and highlighted the noteworthy data points in blue”).

As an example of contextualization, consider selection of a database (see, e.g., database selection 426). Such a database may include associated information such as a link (e.g., resource locator such as a URL), credential information, etc. As an example of contextualization, consider honing in on a well that may be experiencing a flow issue, where a graphic (e.g., model, satellite image, etc.) shows a representation of the well (see, e.g., graphic selection 428). In such an example, the graphic may be from a model (e.g., an earth model, etc.), from a satellite (e.g., optionally live), from a geodatabase (e.g., GIS, etc.). The shape, size, color scheme, markers, etc. of the graphic may optionally be user selected to contextualize the graphic, for example, to better assess the flow issue. As an example, a scenario leading to such a contextualized graphical user interface may be achieved via various steps (e.g., workflow steps, etc.) to identify and focus in on an issue. Once identified, the context for the identified issue may be shared (e.g., transmitted) to another for mitigation, resolution, etc. In such an example, a team may progressively revise context of a graphical user interface, for example, for planning, action taken, results, etc. In such an example, a collection of “contexts” (e.g., as files) may form a case history, optionally for storage in a database in associated with a well, equipment, a location, etc. In the flow issue example, a contextualized graphical user interface after treatment of the well with a descaling fluid may be packed (e.g., via object serialization) and stored, transmitted, etc. (e.g., as evidence to confirm that action was taken, etc.).

As an example, a user at one location may determine a solution to a flow issue that may be represented at least in part by a contextualized graphical user interface, request packing of the context (e.g., a snapshot that includes serialization of one or more objects, associated information, etc.), and transmission of the packed context (e.g., as a file) to a device of another user in the field where the device can re-create the contextualized graphical user interface (e.g., in the same or optionally in a different format such as for a mobile device), for example, to facilitate implementation of the solution (e.g., optionally by the user making further selections, entries, etc., via the re-created contextualized graphical user interface and/or by physically manipulating equipment in the field). In such an example, field data may be communicated as collected from one or more field sensors associated with a well experiencing the flow issue where at least some of the field data may be rendered to a contextualized graphical user interface to visualize consequences of implementation of the solution in the field.

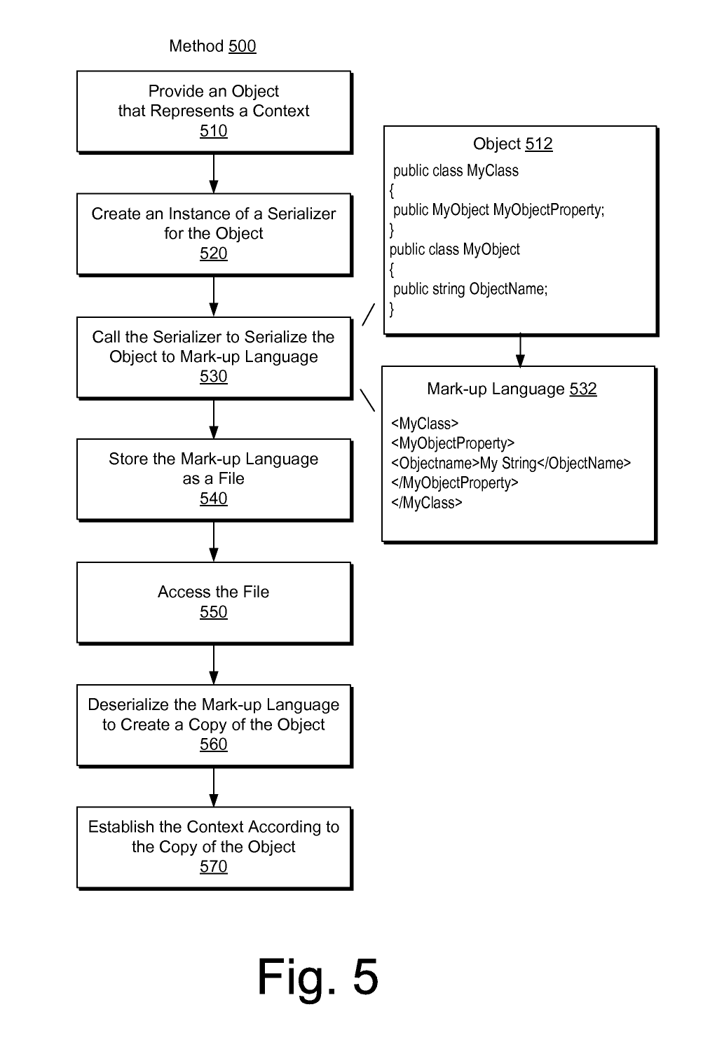

FIG. 5 shows an example of a method 500 and examples of an object 512 and mark-up language 532 that may be associated with the method 500. In the example of FIG. 5, the method 500 includes a provision block 510 for providing an object that represents a context (e.g., a contextualized graphical user interface of a production data management system framework), a creation block 520 for creating an instance of a serializer for the object (e.g., consider a .NET serializer), a call block 530 for calling the serializer to serialize the object to mark-up language (see, e.g., the object 512 and the mark-up language 532), a storage block 540 for storing the mark-up language as a file, an access block 550 for accessing the file, a deserialization block 560 for deserializing the mark-up language to create a copy of the object (e.g., by calling an appropriate process for deserialization), and an establish block 570 for establishing the context according to the copy of the object.

Referring to the example graphical user interface 400 of FIG. 4, the various graphics, graphic controls, etc., may be represented as an object, for example, to be provided in the provision block 510 or to be created as a copy in the deserialization block 560 of the method 500 of FIG. 5.

As an example, a contextualized graphical user interface of a production data management framework may be represented by one or more objects, for example, where context and data (e.g., selected in part via receipt of user input) may be structured using programming language constructs like classes, fields, properties, primitive types, arrays, embedded XML (e.g., optionally as XmlElement class object, XmlAttribute class object, etc.). As an example, a serialization process can include converting one or more objects to information in a serial format (e.g., serial XML or other serial format). As an example, a deserialization process may re-create at least one of the one or more objects (e.g., in original state) from the information in a serial format. As an example, an approach to sharing or storing context can include mapping from programming language constructs of one or more objects that represent the context to XML schema and then from the XML schema to programming language constructs to re-create the context. As an example, a production data management framework may include one or more modules to perform serialization and may include one or more modules to perform deserialization. As an example, one or more modules may be implemented in a form compatible with a browser application configured to access one or more resources (e.g., servers, databases, etc.) via one or more networks (e.g., private, public, mixed). As an example, a browser plug-in may provide functionality (e.g., via executable code, an app, etc.) to perform serialization, deserialization or both serialization and deserialization.

As an example, a production data management system framework may provide components and services for contextualization of a graphical user interface, for example, via receipt of user interaction(s), receipt of a file (e.g., serialized object file), etc. Such components and services may allow for user input, rendering of UI controls, media creation (e.g., media recording), media rendering, data binding, using vector graphics, text, animation, images and language specifying layout(s) (e.g., XAML, etc.). As an example, in such a framework, a context may be represented by one or more objects (e.g., amenable to packing and storage, transmission, etc.).

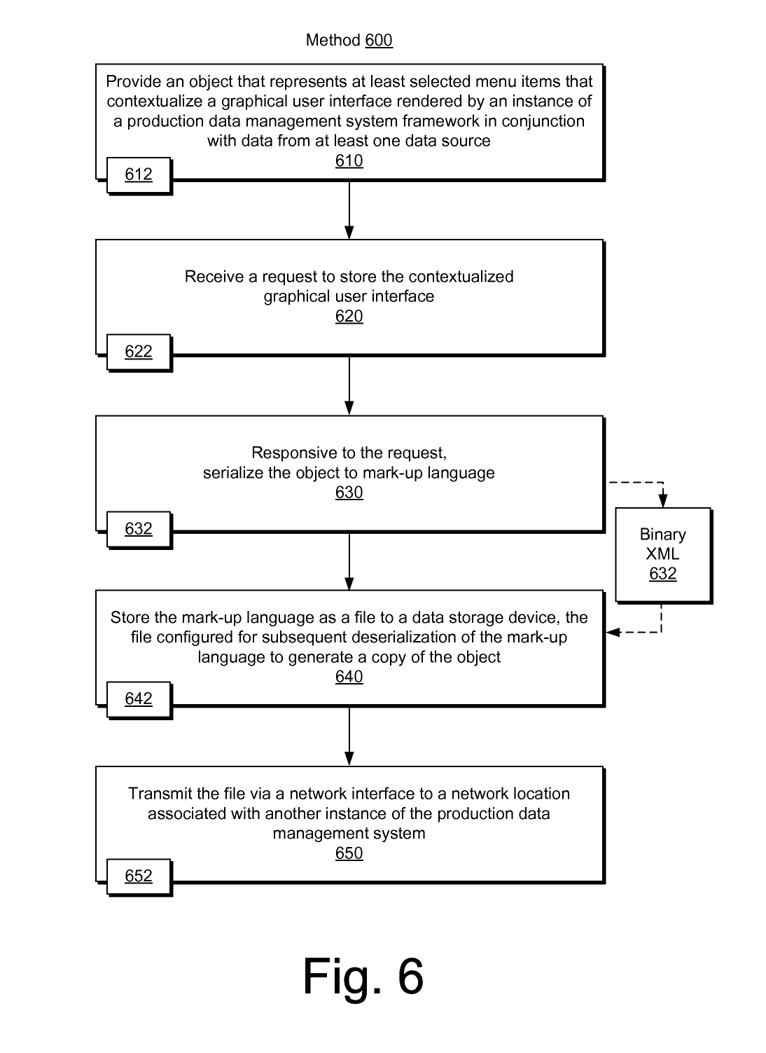

FIG. 6 shows an example of a method 600 that includes a provision block 610 for providing an object that represents at least selected menu items that contextualize a graphical user interface rendered by an instance of a production data management system framework in conjunction with data from at least one data source; a reception block 620 for receiving a request to store the contextualized graphical user interface; a serialization block 630, responsive to the request, for serializing the object to mark-up language (e.g., optionally to a binary markup language 632); a storage block 640 for storing the mark-up language as a file to a data storage device, the file configured for subsequent deserializing of the markup language for generating a copy of the object and for rendering of the contextualized graphical user interface according to the copy of the object; and a transmission block 650 for transmitting the file via a network interface to a network location associated with another instance of the production data management system framework. Such a method may further include, for example, a deserialization block for deserializing the mark-up language in the file, an access block for accessing the data from the at least one data source, a generation block for generating a copy of the object and a render block for rendering the contextualized graphical user interface according to the copy of the object.

The method 600 is shown in FIG. 6 in association with various computer-readable media (CRM) blocks 612, 622, 632, 642 and 652. Such blocks generally include instructions suitable for execution by one or more processors (or cores) to instruct a computing device or system to perform one or more actions. While various blocks are shown, a single medium may be configured with instructions to allow for, at least in part, performance of various actions of the method 600. As an example, a computer-readable medium (CRM) may be a computer-readable storage medium.

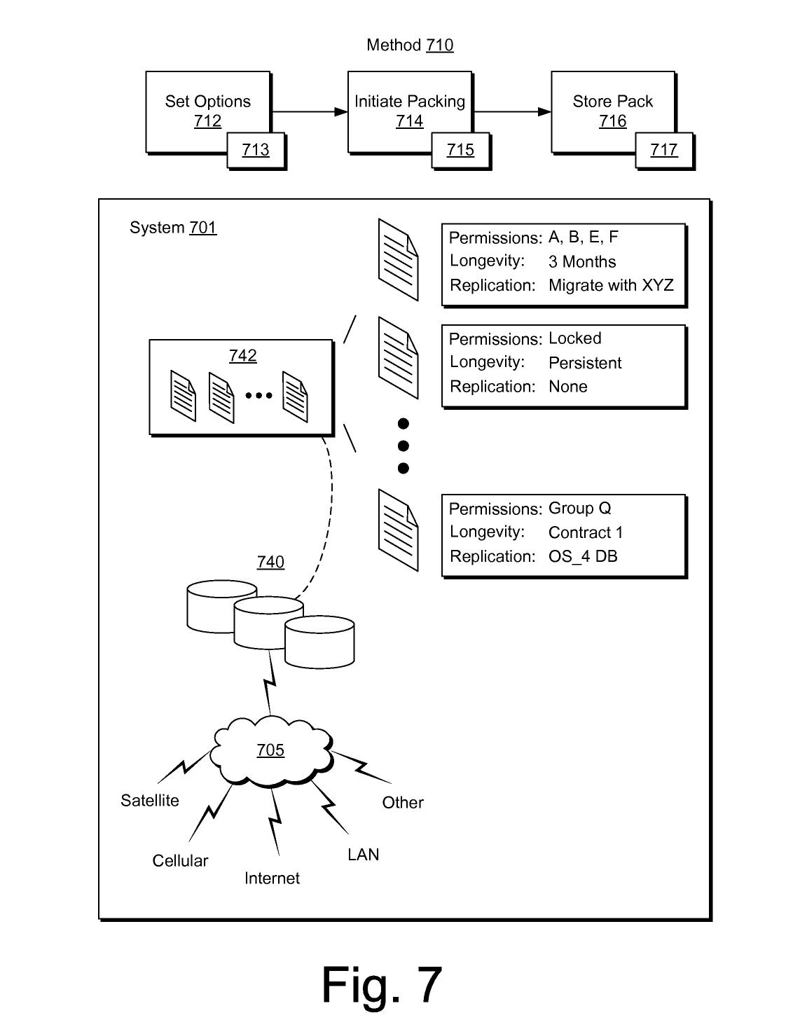

FIG. 7 shows an example of a system 701 and a method 710. The system includes one or more networks 705, one or more storage devices 740 and one or more packs 742 that pack contexts. In the example of FIG. 7, each of the packs may have one or more associated properties. For example, each of the packs 742 may include one or more permissions, one or more time properties (e.g., longevity), one or more replication properties, etc.

In the example of FIG. 7, the method 710 includes a set block 712 for setting one or more options (e.g., one or more file properties), an initiation block 714 for initiating packing of a pack and a storage block 716 for storing the pack according to the setting of the one or more options.

The method 710 is shown in FIG. 7 in association with various computer-readable media (CRM) blocks 713, 715, and 717. Such blocks generally include instructions suitable for execution by one or more processors (or cores) to instruct a computing device or system to perform one or more actions. While various blocks are shown, a single medium may be configured with instructions to allow for, at least in part, performance of various actions of the method 710. As an example, a computer-readable medium (CRM) may be a computer-readable storage medium.

As an example, a production data and management client may also accept requests from a user to create and restore bookmarks. For example, a user may follow a particular workflow when working with a production data management system framework. As other priorities arise, the user may stop the workflow and later return to the workflow by restoring a bookmark. As such, the selected data and settings may be defined by a restored bookmark.

As an example, creating and restoring bookmarks can provide a user with a method to return to a stopping point in a workflow, or share a particular screen context snapshot, for example, without having to repeat actions that lead to the stopping point. In other words, a user may re-create a screen context without having to re-select features, repeat edits, and markings, or re-define display preferences. As an example, a bookmark may be described as a save point, or snapshot, during the user's workflow.

As an example, a user may be looking at a particular set of data they wish to share with a colleague. In such an example, a user may send the saved bookmark to that colleague who can then restore the settings on a separate computer. As an example, bookmarks may be displayed on a host client as bookmark thumbnails. In such an example, a user may restore one of the bookmarks by clicking on the relevant bookmark thumbnail.

As an example, one or more bookmarks may be saved as files, and be able to be emailed or sent otherwise electronically. In such an example, opening a file would open a production data management system framework application and bring the user directly to the bookmarked context.

As an example, bookmarks may include pointers to associated selected data and settings within one or more associated databases. As an example, bookmarks may be stored in an extensible markup language (XML) format, and may also be compressed and/or encrypted.

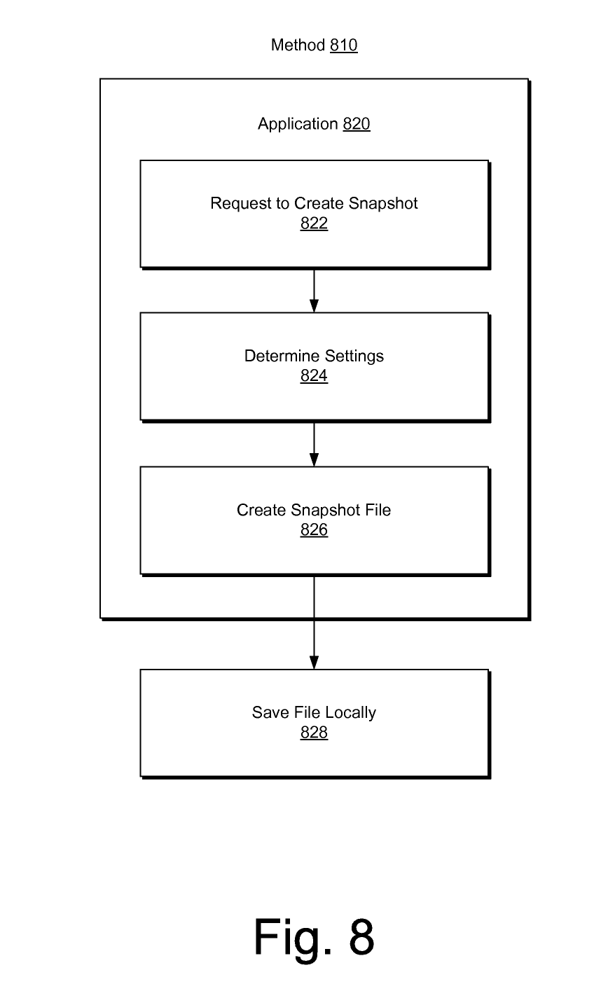

FIG. 8 shows an example of a method 810 for creating a bookmark in a production data management system framework. The method 810 may be performed, for example, by a client of a production data and management framework. The method 810 includes an application 820 that includes one or more modules such as a request module 822 for requesting creation of a snapshot, a determination block 824 for determining one or more settings associated with a context for the snapshot, and a creation block 826 for creating a snapshot file. The method 810 may include save block 828 for saving the file, for example, locally (e.g., to memory of a client device).

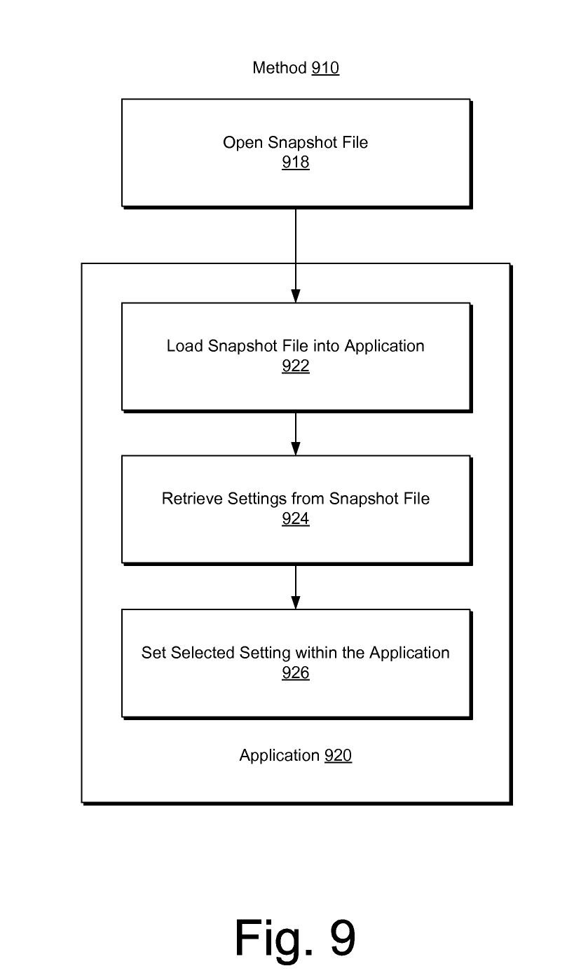

FIG. 9 shows an example of a method 910 for restoring a bookmark in a product data and management system framework. As an example, the method 910 may be performed by a client of a production data management system framework. The method 910 includes an open block 918 for opening a snapshot file (see, e.g., the save block 828 of the method 810 of FIG. 8) and an application 920 that includes one or more modules such as a load module 922 for loading the snapshot file into the application, a retrieval block 924 for retrieving one or more settings associated with the context of the snapshot file, and a set block 926 for setting selected setting with the application to re-creation the context of the snapshot file.

As an example, the methods 810 and 910 of FIGS. 8 and 9 may be executed on different computing devices (see, e.g., the system 301 of FIG. 3). As an example, creating and restoring bookmarks may operate with respect to instances of a product data and management system framework where, for example, each of the instances can access the appropriate data, whether from the same data storage or from another data storage. As an example, where a single data storage stores the data for a context, a condition may be checked to ensure that access is available before trying to re-establish a context.

As an example, a method for creating a bookmark for production data management system framework can include displaying a set of production data on a computer screen; receiving a request to create the bookmark, where the bookmark represents a state of the displayed data and data context, and may include one or more of the settings of the production data and management framework; determining the settings; and creating the bookmark.

As an example, a system can include one or more processors; memory; a network interface for accessing at least one data storage device; instructions stored in the memory and executable by the one or more processors to execute an instance of a production data management system framework; render a graphical user interface of the production data management system framework that includes user selectable items to contextualize the graphical user interface and data from the at least one data storage device; receive commands for selection of one or more of the user selectable items to contextualize the graphical user interface; generate an object that represents the contextualized graphical user interface and data from the at least one data storage device; responsive to receipt of a request, seriealize the object to mark-up language; and store the mark-up language as a file to the memory or one or more of the at least one data storage device, the file configured for subsequent deserialization of the mark-up language to generate a copy of the object to render the contextualized graphical user interface. As an example, such a system may also include instructions stored in the memory and executable by the one or more processors to receive a file that includes markup language from serialization of an object of a contextualized graphical user interface, to deserialize the mark-up language to a copy of the object and to re-create a contextualized graphical user interface according to the copy of the object. In such an example, the received file may be a file previously stored (e.g., by the same user).

As an example, a system can include instructions stored in memory and executable by one or more processors to call a communication application for transmission of a file via the communication application, for example, where the content of the file was generated by serialization of an object that represents a contextualized graphical user interface. As an example, such a file may include an extension recognizable by an operating system as being associated with a production data and management system framework. As an example, a file may be a binary file.

As an example, a system may include instructions stored in memory and executable by one or more processors to receive a file packed with markup language and information for accessing data from at least one data storage device, to unpack the mark-up language and information in the file and to re-create a contextualized graphical user interface according to the unpacked mark-up language and information in the file. As an example, the received file may be a file packed by the system.

As an example, one or more computer-readable storage media can include computer-executable instructions to instruct a computing device to: receive a file that includes serialized mark-up language and information for accessing one or more data storages; deserialize the mark-up language and information for accessing the one or more data storages; execute an instance of a production data management system framework; and generate a graphical user interface of the production data management system framework based at least in part on the deserialized mark-up language and information for accessing the one or more data storages. In such an example, the one or more computer-readable storage media can include computer-executable instructions to instruct a computing device to: access data from the one or more data storages based on the deserialized information for accessing the one or more data storages (e.g., a data storage device or devices).

As an example, one or more computer-readable storage media can include computer-executable instructions to instruct a computing device to: render a graphical user interface of the production data management system framework that includes user selectable items to contextualize the graphical user interface and data from the one or more data storages; receive commands for selection of one or more of the user selectable items to contextualize the graphical user interface; generate an object that represents the contextualized graphical user interface and data from the data from the one or more data storages; and responsive to receipt of a request, serialize the object to mark-up language (e.g., in the form of a file). In such an example, instructions may be included to instruct a computing device to store a file of the mark-up language to one of the one or more data storages.

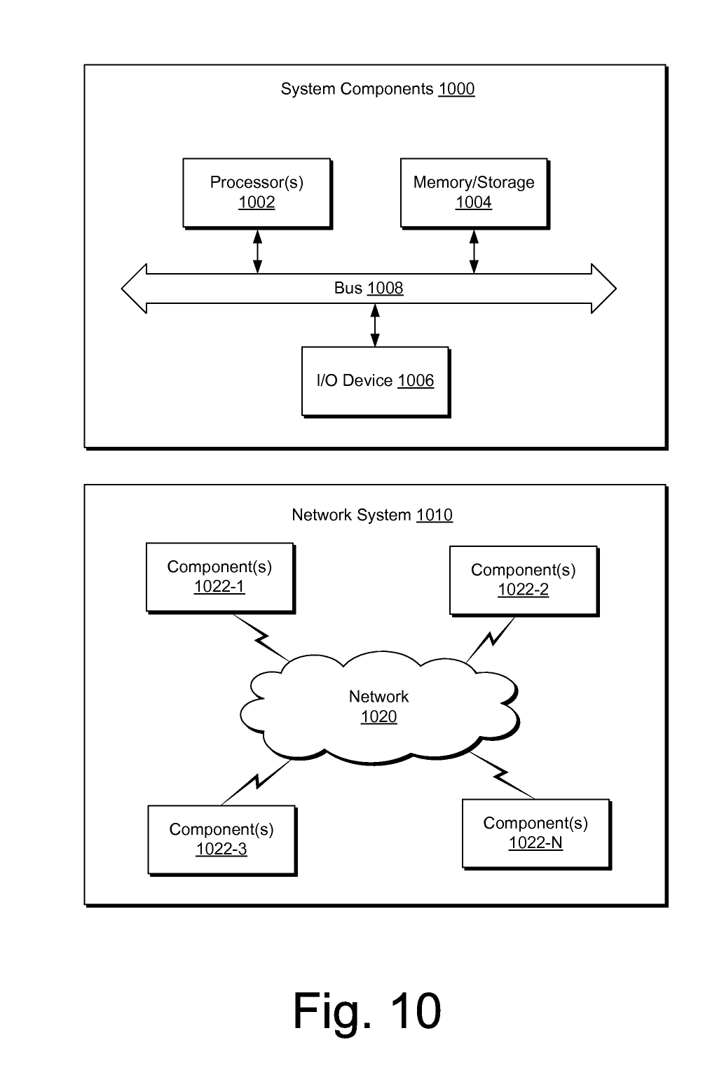

FIG. 10 shows components of an example of a computing system 1000 and an example of a networked system 1010. The system 1000 includes one or more processors 1002, memory and/or storage components 1004, one or more input and/or output devices 1006 and a bus 1008. In an example embodiment, instructions may be stored in one or more computer-readable media (e.g., memory/storage components 1004). Such instructions may be read by one or more processors (e.g., the processor(s) 1002) via a communication bus (e.g., the bus 1008), which may be wired or wireless. The one or more processors may execute such instructions to implement (wholly or in part) one or more attributes (e.g., as part of a method). A user may view output from and interact with a process via an I/O device (e.g., the device 1006). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1010. The network system 1010 includes components 1022-1, 1022-2, 1022-3, . . . 1022-N. For example, the components 1022-1 may include the processor(s) 1002 while the component(s) 1022-3 may include memory accessible by the processor(s) 1002. Further, the component(s) 1022-2 may include an I/O device for display and optionally interaction with a method. The network may be or include the Internet, an intranet, a cellular network, a satellite network, etc.

Although a few example embodiments have been described in detail above, those skilled in the art will readily appreciate that many modifications are possible in the example embodiments without materially departing from the embodiments of the present disclosure. Accordingly, such modifications are intended to be included within the scope of this disclosure as defined in the following claims. In the claims, means-plus-function clauses are intended to cover the structures described herein as performing the recited function and not just structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words “means for” together with an associated function.

1. A method comprising:
providing an object that represents at least selected menu items that contextualize a graphical user interface rendered by an instance of a production data management system framework in conjunction with data from at least one data source;
receiving a request to store the contextualized graphical user interface;
responsive to the request, serializing the object to mark-up language; and
storing the mark-up language as a file to a data storage device, the file configured for subsequent deserializing of the mark-up language for generating a copy of the object and for rendering of the contextualized graphical user interface according to the copy of the object.

2. The method of claim 1 further comprising transmitting the file via a network interface to a network location associated with another instance of the production data management system framework.

3. The method of claim 2 further comprising deserializing the mark-up language in the file, accessing the data from the at least one data source, generating a copy of the object and rendering the contextualized graphical user interface according to the copy of the object.

4. The method of claim 1 wherein serializing the object comprises serializing the object to an extensible mark-up language of an XML standard.

5. The method of claim 1 wherein the selected menu items comprise a selected menu item for a graph of at least some of the data from the at least one data source.

6. The method of claim 5 where the selected menu item for the graph comprises at least one member selected from a group consisting of an axis value, a color, and a line style.

7. The method of claim 1 wherein the selected menu items comprise a selected menu item for a date.

8. The method of claim 1 wherein storing the file to a data storage device comprises storing the file as having one or more permissions.

9. The method of claim 1 wherein the production data management system framework comprises an oil and gas production data management system framework.

10. A system comprising:
one or more processors;
memory;
a network interface for accessing at least one data storage device;
instructions stored in the memory and executable by the one or more processors to
execute an instance of a production data management system framework;
render a graphical user interface of the production data management system framework that comprises user selectable items to contextualize the graphical user interface and data from the at least one data storage device;
receive commands for selection of one or more of the user selectable items to contextualize the graphical user interface;
generate an object that represents the contextualized graphical user interface and data from the at least one data storage device;
responsive to receipt of a request, seriealize the object to markup language; and
store the mark-up language as a file to the memory or one or more of the at least one data storage device, the file configured for subsequent deserialization of the mark-up language to generate a copy of the object to render the contextualized graphical user interface.

11. The system of claim 10 further comprising instructions stored in the memory and executable by the one or more processors to receive a file that comprises markup language from serialization of an object of a contextualized graphical user interface, to deserialize the mark-up language to a copy of the object and to re-create a contextualized graphical user interface according to the copy of the object.

12. The system of claim 11 wherein the received file comprises the stored file.

13. The system of claim 11 wherein the instructions comprises instructions to execute an instance of the production data management system framework.

14. The system of claim 10 further comprising instructions stored in the memory and executable by the one or more processors to call a communication application for transmission of the file via the communication application.

15. The system of claim 10 wherein the file comprises an extension recognizable by an operating system as being associated with the production data and management system framework.

16. The system of claim 10 wherein the file comprises a binary file.

17. One or more computer-readable storage media comprising computer-executable instructions to instruct a computing device to:
receive a file that comprises serialized mark-up language and information for accessing one or more data storages;
deserialize the mark-up language and information for accessing the one or more data storages;
execute an instance of a production data management system framework; and
generate a graphical user interface of the production data management system framework based at least in part on the deserialized mark-up language and information for accessing the one or more data storages.

18. The one or more computer-readable storage media of claim 18 further comprising computer-executable instructions to instruct a computing device to:
access data from the one or more data storages based on the deserialized information for accessing the one or more data storages.

19. The one or more computer-readable storage media of claim 18 further comprising computer-executable instructions to instruct a computing device to:
render a graphical user interface of the production data management system framework that comprises user selectable items to contextualize the graphical user interface and data from the one or more data storages;
receive commands for selection of one or more of the user selectable items to contextualize the graphical user interface;
generate an object that represents the contextualized graphical user interface and data from the data from the one or more data storages; and
responsive to receipt of a request, serialize the object to mark-up language.

20. The one or more computer-readable storage media of claim 19 further comprising computer-executable instructions to instruct a computing device to:
store the mark-up language as a file to one of the one or more data storages.
